(19) United States
(12) Patent Application Publication
(10) Pub. No.: US 2009/0158170 A1
(43) Pub. Date: Jun. 18, 2009

(54) AUTOMATIC PROFILE-BASED AVATAR GENERATION

(76) Inventors: Rajesh NARAYANAN, San Jose, CA (US); Maud Cahuzac, San Francisco, CA (US)

Correspondence Address: THORNE & HALAJIAN;APPLIED TECHNOLOGY CENTER, 111 WEST MAIN STREET, BAY SHORE, NY, 11706, US

(21) Appl. No.: 11/956,354

(22) Filed: Dec. 14, 2007

(51) Int. Cl. G06F 3/00

(52) U.S. Cl. 715/753

(57) ABSTRACT

A system, method and device for providing an avatar for interaction in a virtual environment. A user provides a user identifier and a user profile not associated with an avatar is retrieved based on the user identifier. Avatar characteristics are determined based on the retrieved user profile. The virtual environment is rendered with an avatar based on the determined avatar characteristics. The retrieved user profile may include at least one of a default profile, an advertiser supplied profile, a profile associated with a given user and a profile associated with the virtual environment.

### FIELD OF THE PRESENT SYSTEM

The present system relates to a method and apparatus for creating an avatar for interacting with a virtual environment.

### BACKGROUND OF THE PRESENT SYSTEM

Users may interact within a virtual environment using an avatar that represents the user's “presence” within the virtual environment. These virtual environments are typically visually very rich and complex. In interacting with some virtual environments, such as a virtual gaming environment, users may be provided with a default set of avatar characteristics and thereby, a default one or more avatars (e.g., characters) that may be utilized for interaction with the virtual gaming environment. Further, some virtual environments enable personalization of an avatar to better suit individual users. These personalizations may be stored utilizing a personalization file that is directly related to the avatars characteristics.

However, in creating these personalizations to experience virtual environments, users typically need to invest a lot of time in creating an avatar and personalizing it. Moreover, if users are willing to log into various virtual environments, the user typically has to create a different avatar for each virtual environment visited.

As a consequence of this up-front time commitment for creating an avatar, most users don't experience virtual worlds because the user does not want to go through this long and uneasy process of creating an avatar account and profile.

Advertising Brands would like to utilize a virtual presence to promote its products but the user's up-front time commitment affects the Brands abilities to engage new users in the virtual environments. Most Brands have invested a lot of money to have a presence on virtual worlds, only to see a lack of user's presence in interacting with the virtual worlds. Further, existing users may go away due to the bad quality of the virtual environment experience yet Brands are hesitant to invest further moneys into the virtual environment that to date, brings in comparatively little “eyeballs” or traffic.

Advertisers would like to extend advertising to these virtual worlds yet a problem exists in that even though there may be many users logged in to the virtual environment at any given time, the number of eyeballs viewing any given portion of the virtual environment, such as a Brands particular environment, is limited since the virtual environments are very large. This problem will not go away even if the number of users/avatars of the virtual environments increases significantly. The number of new users choosing to interact with virtual environments pales in comparison to what is considered as a critical mass to generate significant revenue in terms of eyeballs or Cost per Thousand Impressions (Cost Per Mille or CPMs). CPM constitutes a well known concept in the advertisement industry. Those of ordinary skill in the art recognize the limitations of virtual worlds in accordance with prior systems to generate significant revenue based on CPM.

It is an object of the present system to overcome disadvantages and/or make improvements in the prior art.

### SUMMARY OF THE PRESENT SYSTEM

The present system includes a system, method and device for providing an avatar for interaction in a virtual environment. The method of the present system includes providing a user identifier, retrieving a user profile not associated with an avatar based on the user identifier, determining avatar characteristics based on the retrieved user profile, and rendering the virtual environment and an avatar based on the determined avatar characteristics. In one embodiment, the retrieved user profile includes at least one of a default profile, an advertiser supplied profile, a profile associated with a given user and a profile associated with the virtual environment.

The retrieved user profile may include a description of physical characteristics of the given user. The retrieved user profile may include a description of at least one of objects purchased by the given user and content rendered to the user. The retrieved user profile may include a description of a purchaser of the advertiser's products even if the user identifier is not associated with a user that is a purchaser of the advertiser's products. In one embodiment, the user profile may include profile elements. Determining avatar characteristics may include modifying avatar characteristics base on the profile elements.

In one embodiment, determining avatar characteristics may include determining avatar characteristics based on a profile associated with a given user and modifying the determined avatar characteristics based on at least one of an advertiser supplied profile and a profile associated with the virtual environment. In accordance with the present system, a user may receive a solicitation to interact with the virtual environment. A user of the present system may browse content available over a server network prior to receiving an advertising solicitation received from the server network. In accordance with one embodiment of the present system, the system may create an avatar without user intervention. The user profile may include at least one of an explicit and implicit user profile associated with a given user.

### BRIEF DESCRIPTION OF THE DRAWINGS

The invention is explained in further detail, and by way of example, with reference to the accompanying drawings wherein:

FIG. 1 shows a system in accordance with an embodiment of the present system;

FIG. 2 shows a process flow diagram in accordance with an embodiment of the present system; and

FIG. 3 shows a portion of a system (e.g., client, server, proxy, etc.) in accordance with an embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, etc. However, it will be apparent to those of ordinary skill in the art that other embodiments that depart from these details would still be understood to be within the scope of the appended claims. Moreover, for the purpose of clarity, detailed descriptions of well known devices, circuits, techniques and methods are omitted so as not to obscure the description of the present system. It should be expressly understood that the drawings are included for illustrative purposes and do not represent the scope of the present system.

For purposes of simplifying a description of the present system, the term rendering and formatives thereof as utilized herein refer to providing content, such as content related to a virtual environment including a presence of an avatar depicted within and interacting with the virtual environment, such that it may be perceived by at least one user sense (e.g., sense of sight and/or a sense of hearing). For example, a rendered virtual world may include audio data, visual data, and/or textual data, etc., that is perceivable by the user, for example via a user rendering device accessing a server that is hosting the virtual environment. The term “operatively coupled” and formatives thereof as utilized herein refer to a connection between devices or portions thereof that enables operation in accordance with the present system. For example, an operative coupling may include one or more of a wired connection and/or a wireless connection between two or more devices that enables a one and/or two-way communication path between the devices or portions thereof.

The system and method described herein address problems in prior art systems. In accordance with an embodiment of the present system, a system, method and device may provide a user with an ability to automatically and instantly interact with a Brand in a Virtual Environment without a need for the user to have an account within the virtual environment where the immersion takes place. The present system aims at creating temporary user profile-based avatars for users to automatically and easily immerse themselves in a virtual world. Hence, in accordance with the present system, the user does not need to have an account associated with the virtual environment in order to experience the virtual environment and its objects including objects associated with an Advertiser's Brand.

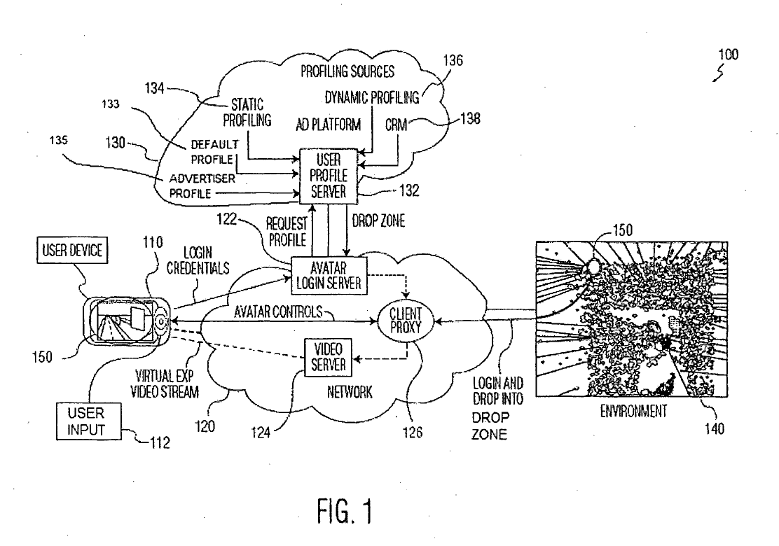

FIG. 1 shows a system 100, one or more portions of which may be utilized for operation in accordance with the present system. The system 100 may include a user device 110 that interacts with a virtual environment 140 via a network 120. The system 100 further includes one or more profiling sources 130 that interact with the network 120 for purposes of providing user profile elements to an avatar login server 122 for avatar creation/modification. The avatar login server 122 is operatively coupled to the user device 110 and a client proxy 126 that provides the user device 110 access to the virtual environment 140 including a drop-zone 150 of the virtual environment 140. The network 120 also includes a video server 124, which may host the virtual environment. The video server 124 may be operatively coupled to the client proxy 126 and the user device 110. As may be readily appreciated, the video server 124 may include one or more storage devices and processing units for providing the virtual environment 140 and the created/modified avatar to the user device 110 as well as storing elements of the user device 110 unique to a given user device 110 and/or unique to a given user (e.g., user identification information) to aid in current and subsequent accessing of the virtual environment. As may be readily appreciated, elements unique to the user device 110 and the given user may also be stored directly on the user device 110 in accordance with the present system and/or may be stored within the network 120, such as on a server accessible through the network 120. In one embodiment, elements unique to the user device 110 and the given user may be stored directly (e.g., solely) on the user device 110 to address privacy concerns of the user.

The profiling sources 130 includes a user profiling server 132 that may include user/user device profiling sources such as static profiling 134, dynamic profiling 136, customer relationship management (CRM) software 138, etc. For example, the profiling sources 130, as may be readily appreciated by a person of ordinary skill in the art, may include implicit profiling, explicit profiling, and/or combinations thereof to provide a user profile for the given user of the user device 110. The profile may also include user identifying information to associate the profile with the given user.

In accordance with the present system, a temporary avatar may be selected from an avatar database, such as stored in the avatar login server 122 and/or may be created/modified for the duration of immersion into a virtual environment 140. Moreover, a selection and/or creation/modification of the avatar may be based on user profile information, such as opt-in information that the user is willing to share with a network operator, such that basic information (age, gender, physical characteristics, etc.) or preferences are utilized for avatar selection and/or creation/modification. In any event, the user profile may be stored or accessed by the user profile server 132.

Since the user's avatar, whether selected and/or created/modified, that is used for interaction with the virtual environment 140 will reflect characteristics or preferences that are familiar and/or desirable to the user, it is likely that the user will become more fully immersed in the virtual environment. Wherein characteristics of the user are utilized for avatar selection/creation/modification, the avatar's interaction within the virtual environment may provide an increased perception of reality from the view point of the user and thereby lead to further user participation with this or other virtual environments.

In addition, other profiling elements related to avatar creation or unrelated may also be incorporated into avatar creation. For example, a profile provided by an advertiser 135 may also be incorporated into avatar selection/creation/modification. In this way, an avatar entering an advertiser provided virtual environment may also be selected/created/modified to exhibit characteristics of the advertiser supplied profile 135, such as exhibiting cloths, products, logos and/or other characteristics of the advertiser as provided in the advertiser profile 135. For example, an avatar being created based on a user profile and/or a default profile 133, may be modified in accordance with the advertiser supplied profile 135, such as “a typical BMW purchaser” as determined by advertiser supplied profile elements.

It should be understood by the description contained herein that the profile elements of any of a user profile, default profile and advertiser profile are not elements typically stored in a profile for an avatar created under prior systems. In accordance with the present system, the profiles described herein are not simply a storing of a physical description of an avatar as provided in prior systems wherein an avatar may be created and thereafter have avatar descriptive elements stored in a file for later retrieval and use of the avatar. While the present system may allow for a later storage of a typical avatar profile after avatar creation, the profiles of the user, default and advertiser as described herein are not merely stored avatar profile elements.

For example, a user profile in accordance with the present system may include elements that are acquired explicitly and/or implicitly from the user and are related to other activities outside a realm of avatar creation. A typical user profile may include an identification of products purchased by the user. In this way, an avatar created utilizing this user profile may be created having attributes related to the purchased products, such as wearing clothing and/or products that the user may have purchased. The user profile may also include other user information such as the user's gender, physical characteristics, etc. In this way, the user will be instantly familiar with an avatar created utilizing this user profile and will be more likely to become immersed into a virtual environment wherein the avatar interacts.

The default profile 133 may be provided to facilitate avatar creation wherein user specific information is not available or may be utilized to modify elements of the user and/or advertiser provided profile. For example, a default profile 133 may provide attributes related to an intended virtual environment wherein the avatar will interact. In this way, an avatar otherwise created for a given virtual environment, such as a social network, may be modified to include attributes relevant for another given virtual environment, such as an activity-based virtual environment, when the avatar is utilized at some later date to interact in the other given virtual environment. Similarly, the advertiser provided profile 135 may modify the avatar to “fit” an advertiser provided virtual environment, such as being provided with further characteristics, such as appearance (e.g., products, symbols, physical attributes and/or other characteristics) and/or temperament, that an advertiser desires. Naturally, a user going through avatar creation may have an option to reject profile elements provided from any one or more of the provided profiles. In accordance with the present system, an avatar created by a user for interaction in a first virtual environment may be utilized, without further intervention by the user, in a second virtual environment. While a profile associated with the second virtual environment may modify the avatar utilized with the first virtual environment, the user need not interact, if desired, to bring about the changes and therefore, the user may be more likely to interact with the second virtual environment and/or other virtual environments.

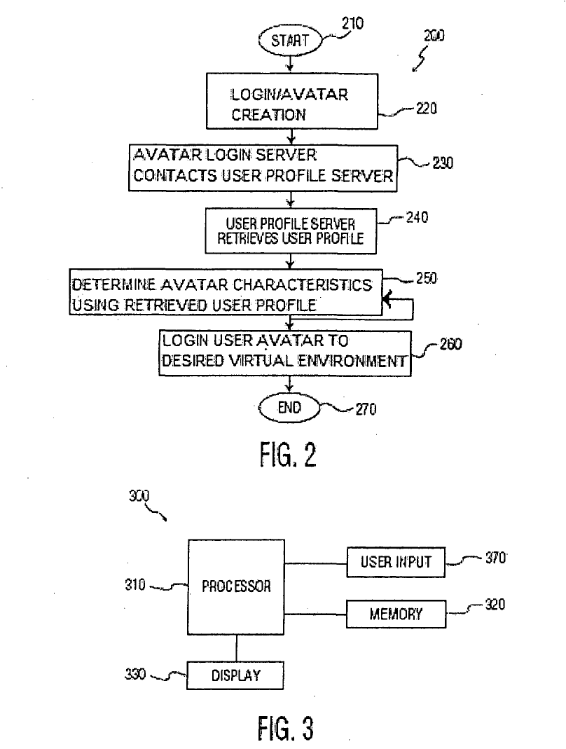

FIG. 2 shows a flow diagram 200 including details of an avatar creation process and login in accordance with an embodiment of the present system. The process begins during act 210 wherein a user activates a user device. Any number of user devices may be suitably employed in accordance with the present system, such as gaming devices (handheld devices, gaming stations, etc.), video players, personal digital assistants (PDAs), set top boxes (STB), televisions, cellular phones, personal computers, etc. The user device may also include a browser based client, like a Java-Applet and/or Flash based program. As may be readily appreciated, in accordance with this embodiment, any device that can support a rendering of content (audio and/or video) transferred from a second party source may be employed as the user device. For example, in one embodiment the second party source need only be a storage device adapted to store a user profile (local and/or remote) and adapted to support the processing acts as described further herein.

During act 220, a user requests a login into a virtual environment. This may occur as a login request to a virtual environment that has never been visited by the user, as a login request to a previously visited virtual environment and/or as a re-spawning of an avatar that has expired within the virtual environment. Illustratively, a login request is discussed to simplify the following discussion. As is readily appreciated, the system may operate similarly regardless of whether the system is employed in avatar selection, creation, and modification. For example, in a process wherein an avatar is selected from a group of potential avatars (e.g., stored in the avatar login server 122 shown in FIG. 1) based on the user profile, the selected avatar may be further modified in accordance with other elements of the user profile, such as profile elements related to the intended virtual environment.

During a login process, a virtual environment client that may be resident on the user device or within the network, contacts a user profiling server via an avatar login server during act 230. The user device provides user identifying information as may be readily appreciated so that the user may be identified and may include information identifying a desired virtual environment. In accordance with the present system, the user profile server retrieves a user profile corresponding to the user of the user device during act 240. While the term “user profile” is utilized herein, it should be understood that the user profile may include one or more of elements that are related to a given user such as may be stored in an implicit and/or explicit user profile. Such elements may include the given users physical attributes, usage characteristics, such as time spent interacting with the user device and other usage characteristics, such as an identification of content (e.g., actual identification, such as program/content names, attributes, genre, etc.) that the user interacts with, rendering habits (e.g., time, place, etc.), purchasing history/habits (e.g., identification of purchased products and purchase locations, such as network locations (URLs), and/or physical locations) as well as any other elements that are associated with the given user that may be utilized to determine avatar characteristics.

In accordance with an embodiment of the present system, the term user profile as utilized herein should also be understood to include in some embodiments, one or more of default profile elements, advertiser profile elements and/or profile elements related to an intended virtual environment. Again however, the user profile should be understood to include more than a simple description of avatar attributes. The user profile elements are elements that are typically not associated with a direct description of an avatar or an association with a given avatar. The user profile includes elements that are unrelated to avatar creation but are utilized to determine a suitable avatar description in accordance with the present system.

As an exemplary description of how one or more elements of the user profile may interact during avatar creation, profile elements directly associated with a given user may be utilized to determine characteristics, such as visual characteristics of an avatar, such as an apparent sex of the avatar. For example, the given user's sex (e.g., male or female) may be utilized to determine the apparent sex of the avatar. Additional user profile elements may include the user's height, eye color, hair length and style, etc. Naturally, the user profile elements may be modified by user selection to enhance or diminish an effect of given user profile elements. For example, while a user's height may be below average, the user may prefer a corresponding avatar be created at above average height. Other such modifications and adjustments to final avatar characteristics, such as eye color, etc., would readily occur to a person of ordinary skill in the art and are intended encompassed by the present system.

Additional profile elements associated with the given user may be utilized to determine, illustratively, an attire of the avatar. For example, a recently purchased and profiled clothing purchase of the user may be utilized to determine an attire of the avatar. Similarly, product purchases, such as jewelry, watches, glasses, etc., may be utilized for determining characteristics, such as visual characteristics, of the avatar.

In an absence of one or more profile elements associated with the given user, default profile elements may be utilized to similarly determine avatar characteristics. The default profile elements may be generically applied to any avatar creation regardless of an intended virtual environment and/or may be generic to a given virtual environment wherein the avatar is intended to interact. For example, generic profile elements may include a sex and height for a typical user (e.g., male, aged 25) and an attire of the avatar may be determined by attributes of the intended virtual environment. A virtual environment related to hiking may include generic profile elements related to clothing elements such as shorts and hiking shoes that may be typical of a user that frequents the hiking virtual environment. Elements that fit a generic profile of a user of other given virtual environments may be readily determined and applied in accordance with the present system. Again it is significant to note that these profile elements are not elements previously associated with an avatar but in fact, are elements that are associated with users. For example, the profile elements employed may be elements that are collected and/or provided for purposes of profiling the user for other purposes, such as for providing advertising, content, recommendations, etc., that is appropriate for a given user. However, in accordance with the present system, the user profile elements are adapted for avatar selection/creation/modification as described herein.

Advertiser profile elements may again be similarly employed to modify avatar selection/creation based on the advertiser profile elements. For example, an avatar that is otherwise selected/created using other profile elements, may thereby be further modified to incorporate or personify the advertiser profile elements. In this way, an avatar that is otherwise determined by other user elements and that may be selected/created/modified for one given virtual environment, may be suitably modified when intended for another given virtual environment.

In any event and regardless of what user profile elements (e.g., generic, user specific, advertiser specific and/or virtual environment specific) are provided by the user profile server, avatar characteristics are determined from the user profile during act 250 and a corresponding avatar description is created. The avatar description is utilized by the present system for describing characteristics of an avatar that is utilized for interaction within a virtual environment. As should be appreciated, the avatar description may be generic for the user's interaction in two or more given virtual environments or may be modified further for interaction within a particular virtual environment so that characteristics of the avatar vary based on the given virtual environment.

As stated above, advertiser profile elements for an advertiser associated with the given virtual environment as well as profile elements associated with the given virtual environment and/or relevant to it may be utilized in bringing about the avatar modification. For example, user sports apparel purchases that are recorded in a user profile may be selectively applied and purchases related to office supplies may be selectively ignored for selection/creation/modification of an avatar intended for a sports related virtual environment. Other portions of the user profile may be similarly applied based on portions of the user profile and/or based on a given virtual environment. Profile elements may also vary simply based on the device utilized for interaction. For example, avatar visual details may be greater or lesser based on rendering/computation capabilities of the device utilized. In any event, the determined avatar description is transferred to the login server which communicates with the client proxy to login the user avatar based on the avatar description to the virtual environment during act 260.

As may be readily appreciated, the proxy mechanism described is only illustrated as one embodiment in accordance with the present system. Alternatively, if the user device, such as a client (device), supports communication with the profiling server, and if the client is capable of rendering the audio and/or visual data related to the virtual world, then the client may directly determine the avatar description and/or login the user's avatar to the virtual environment. In another embodiment, the video server may operate as the client proxy. In any event, thereafter, the user's avatar may be free to wander the virtual environment if desired and the process ends during act 270. Naturally this process of avatar selection/creation/modification may be reinitiated in response to further triggers (e.g., avatar actions, timing, etc.) within the virtual environment such that the user avatar is further modified while interacting with the virtual environment, such as in response to the user's avatar changing locations within the virtual environment. Accordingly, the virtual environments profile elements may change from one location to another, thereby initiating a further modification of the user's avatar (e.g., repeat of act 250). Naturally in this repeat process, act 260 may not need be repeated since the user's avatar may already be logged into the virtual environment.

In accordance with the present system, by determining the avatar description based on the user profile (without or without further user interaction), the initial barrier to the user interacting with a virtual environment is significantly decreased. Thereby, an advertiser may be assured of receiving addition eyeballs that may otherwise not have been inclined to attempt to surmount the initial avatar creation obstacle.

In accordance with the present system, even casual interactions with the virtual environment may be encouraged since the initial setup required to be supervised by the user is greatly diminished or removed completely (e.g., automatic selection/creation/modification). Even advertiser solicitations provided in electronic advertising material may operate as an invitation for a user to “visit” an advertiser's virtual environment. For example, a popup advertisement provided together with content from a server site may operate to transport an avatar, selected/created/modified based on the user profile, to the virtual environment. In this way, the virtual environment may operate as a point of sales or simply as an environment to gain knowledge of an advertiser and/or given products, trademarks, etc. In a further embodiment, a set-top box based client may support the present system. The set-top box client may support a virtual shopping channel and/or television content that operates as the virtual environment. Naturally in a sophisticated virtual environment such as Second Life™, very sophisticated interaction may be enabled.

In accordance with the present system, user's interacting though the user's avatar with the virtual environment will likely be engaged even after initial selection/creation/modification since the user's avatar will be familiar to the user and/or will exhibit characteristics that are desired by the user. In an embodiment wherein the user profile is influenced by physical characteristics of the user, the user perceived reality of the virtual environment may be increased. In these ways, virtual environments may represent a favorable brand-immersion platform.

The present system or portions thereof may be a portion of a client and/or server as described herein. One or more such portions may be resident within the system for operation as described herein.

FIG. 3 shows a portion of a system 300 (e.g., client, server, proxy, etc.) in accordance with an embodiment of the present system. For example, a portion of the present system may include a processor 310 operationally coupled to a memory 320, a display 330 and a user input device 370, such as a user input 112 of the user device 110 depicted in FIG. 1. The memory 320 may be any type of device for storing application data as well as other data related to the described operation. The application data and other data are received by the processor 310 for configuring the processor 310 to perform operation acts in accordance with the present system. The operation acts may include operation in profile selection, creation/modification of avatar characteristics (and thereby characteristics of the avatar) and controlling the display 330 to display content such as the virtual environment and related operation paradigms (e.g., user interface). The user input 370 may include a keyboard, mouse, trackball or other device, including touch sensitive displays, which may be stand alone or be a part of a system, such as part of a personal computer, personal digital assistant, mobile phone, set top box, television or other device for communicating with the processor 310 via any operable link. The user input device 370 may be operable for interacting with the processor 310 including enabling interaction within the virtual environment, selecting elements of the user profile to apply to avatar selection/creation/modification and/or other elements of the present system. Clearly the processor 310, the memory 320, display 330 and/or user input device 370 may all or partly be a portion of a computer system or other device such as a client and/or server as described herein.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 320 or other memory coupled to the processor 310.

The computer-readable medium and/or memory may be any recordable medium (e.g., RAM, ROM, removable memory, CD-ROM, hard drive, DVD, floppy disks and/or memory cards) or may be a transmission medium (e.g., a network comprising fiber-optics, the world-wide web, cables, and/or a wireless channel using time-division multiple access, code-division multiple access, and/or other radio-frequency channel/protocol). Any medium known or developed, or combination thereof, that can store and/or transmit information suitable for use with a computer system may be used as the computer-readable medium and/or memory.

Additional memories may also be used. The memory may be long-term, short-term, or a combination of long-term and short-term memories. These memories configure the processor 310 to implement the methods, operational acts, and functions disclosed herein. The memories may be distributed, for example between the clients and/or servers, or local, and the processor 310, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 310. With this definition, information accessible through a network is still within the memory, for instance, because the processor 310 may retrieve the information from the network for operation in accordance with the present system.

The processor 310 is operable for providing control signals and/or performing operations in response to input signals from the user input device 370 as well as in response to other devices of a network and executing instructions stored in the memory 320. The processor 310 may be an application-specific or general-use integrated circuit(s). Further, the processor 310 may be a dedicated processor for performing in accordance with the present system or may be a general-purpose processor wherein only one of many functions operates for performing in accordance with the present system. The processor 310 may operate utilizing a program portion, multiple program segments, or may be a hardware device utilizing a dedicated or multi-purpose integrated circuit.

Further variations of the present system would readily occur to a person of ordinary skill in the art and are encompassed by the following claims. Through operation of the present system, user profile-based avatars may be provided to a user to enable simple immersion into a virtual environment and its objects.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. A method of providing an avatar for interaction in a virtual environment, the method comprising acts of:
providing a user identifier;
retrieving a user profile not associated with an avatar based on the user identifier;
determining avatar characteristics based on the retrieved user profile; and
rendering the virtual environment and an avatar based on the determined avatar characteristics.

2. The method of claim 1, wherein the retrieved user profile includes at least one of a default profile, an advertiser supplied profile, a profile associated with a given user and a profile associated with the virtual environment.

3. The method of claim 2, wherein the retrieved user profile includes a description of physical characteristics of the given user.

4. The method of claim 2, wherein the retrieved user profile includes a description of at least one of objects purchased by the given user and content previously rendered to the user.

5. The method of claim 1, wherein the retrieved user profile includes a description of a purchaser of the advertiser's products even if the user identifier is not associated with a user that is a purchaser of the advertiser's products.

6. The method of claim 1, wherein the user profile includes profile elements and wherein the act of determining avatar characteristics comprises an act of modifying avatar characteristics base on the profile elements.

7. The method of claim 1, wherein the act of determining avatar characteristics comprises acts of:
determining avatar characteristics based on a profile associated with a given user; and
modifying the determined avatar characteristics based on at least one of an advertiser supplied profile and a profile associated with the virtual environment.

8. The method of claim 7, wherein the act of determining avatar characteristics comprises an act of selectively applying elements of the profile associated with the user based on the virtual environment.

9. The method of claim 1, comprising an act of receiving a solicitation to interact with the virtual environment.

10. The method of claim 9, comprising an act of browsing content available over a server network prior to receiving the solicitation, wherein the solicitation is received from the server network.

11. The method of claim 1, wherein the acts are performed without user intervention.

12. The method of claim 1, wherein the user profile includes at least one of an explicit and implicit user profile associated with a given user.

13. An application embodied on a computer readable medium arranged to provide an avatar for interaction in a virtual environment, the application comprising:
a portion configured to provide a user identifier;
a portion configured to retrieve a user profile not associated with an avatar based on the user identifier;
a portion configured to determine avatar characteristics based on the retrieved user profile; and
a portion configured to render the virtual environment and an avatar based on the determined avatar characteristics.

14. The application of claim 13, wherein the retrieved user profile includes at least one of a default profile, an advertiser supplied profile, a profile associated with a given user and a profile associated with the virtual environment.

15. The application of claim 14, wherein the retrieved user profile includes a description of physical characteristics of the given user.

16. The application of claim 14, wherein the retrieved user profile includes a description of at least one of objects purchased by the given user and content previously rendered to the user.

17. The application of claim 13, wherein the retrieved user profile includes a description of a purchaser of the advertiser's products even if the user identifier is not associated with a user that is a purchaser of the advertiser's products.

18. The application of claim 13, wherein the user profile includes profile elements and wherein the act of determining avatar characteristics comprises an act of modifying avatar characteristics base on the profile elements.

19. The application of claim 13, wherein the portion configured to determine avatar characteristics comprises:
a portion configured to determine avatar characteristics based on a profile associated with a given user; and
a portion configured to modify the determined avatar characteristics based on at least one of an advertiser supplied profile and a profile associated with the virtual environment.

20. The application of claim 19, wherein the portion configured to determine avatar characteristics comprises a portion configured to selectively apply elements of the profile associated with the user based on the virtual environment.

21. The application of claim 13, comprising a portion configured to receive a solicitation to interact with the virtual environment.

22. The application of claim 21, comprising a portion configured to brows content available over a server network prior to receiving the solicitation, wherein the solicitation is received from the server network.

23. The application of claim 13, wherein each of the portions are configured to operate without user intervention.

24. The application of claim 13, wherein the user profile includes at least one of an explicit and implicit user profile associated with a given user.
